(19) United States
(12) Patent Application Publication
(10) Pub. No.: US 2008/0053971 A1
(43) Pub. Date: Mar. 6, 2008

(54) Via hole machining method

(75) Inventors: Yutaka Kobayashi, Ota-ku (JP); Keiji Nomaru, Ota-ku (JP); Hiroshi Morikazu, Ota-ku (JP)

Correspondence Address: GREER, BURNS & CRAIN, 300 S WACKER DR, 25TH FLOOR, CHICAGO, IL, 60606, US

(73) Assignee: Disco Corporation, Tokyo (JP)

(21) Appl. No.: 11/895,821

(22) Filed: Aug. 28, 2007

(30) Foreign Application Priority Data
Sep. 6, 2006 (JP) 2006-241269

(51) Int. Cl. B23K 26/00

(52) U.S. Cl. 219/121.61

(57) ABSTRACT

A via hole machining method for forming via holes, reaching bonding pads, in a wafer having a plurality of devices which are formed on a face side of a substrate and are provided with the bonding pads, by irradiation with a pulsed laser beam from a back side of the substrate, wherein the energy density per pulse of the pulsed laser beam is set at such a value that ablation of the substrate will occur but ablation of the bonding pad will not occur, and the time interval of pulses of the pulsed laser beam is set at a value of not less than 150 microseconds.

### BACKGROUND OF THE INVENTION

1. Field of the Invention

The present invention relates to a via hole machining method for forming via holes, reaching bonding pads, in a wafer having a plurality of devices which are formed on a face side of a substrate and are provided with the bonding pads, by irradiation with a pulsed laser beam from a back side of the substrate.

2. Description of the Related Art

In the process of manufacturing a semiconductor device, a plurality of regions are demarcated by planned split lines called streets which are arranged in a lattice pattern on a face side of a roughly circular disk-like semiconductor wafer, and devices such as ICs and LSIs are formed respectively in the demarcated regions. Then, the semiconductor wafer is cut along the streets to split it into the regions provided with the devices, thereby producing individual semiconductor chips.

In order to manufacture devices with smaller size and higher functions, a module structure has been put to practical use in which a plurality of semiconductor chips are stacked and bonding pads of the stacked semiconductor chips are connected to each other. The module structure is so configured that a plurality of devices are formed on the face side of a substrate constituting a semiconductor wafer and are provided with bonding pads, minute holes (via holes) reaching the bonding pads are bored in the bonding pad-provided portions from the back side of the substrate, and the via holes are filled up with a conductive material, such as aluminum and copper, for connection with the bonding pads (refer to, for example, Japanese Patent Laid-Open No. 2003-163323).

The via holes formed in the semiconductor wafer as above-mentioned are generally formed by use of a drill. However, the via holes provided in the semiconductor wafer have small diameters of 100 to 300 μm, and boring by use of a drill is not necessarily satisfactory in regard of productivity. Moreover, since the thickness of the bonding pads is about 1 to 5 μm, an extremely precise control of the drill is needed for forming the via holes in only the substrate made of silicon or the like constituting the wafer, without damaging the bonding pads.

In order to solve the just-mentioned problem, the present applicant has proposed, in Japanese Patent Application No. 2005-249643, a wafer boring method in which a wafer having a plurality of devices formed on the face side of a substrate, the devices being provided with bonding pads, is irradiated with a pulsed laser beam from the back side of the substrate, whereby via holes reaching the bonding pads are formed efficiently.

The pulsed laser beam used in the wafer boring method as above-mentioned is set to have such an energy density that ablation of the substrate constituting the wafer will take place efficiently but ablation of the bonding pad will not occur. Meanwhile, in order to provide the substrate of the wafer with the via hole reaching the bonding pad, it is necessary to irradiate the substrate with 40 to 80 pulses of the pulsed laser beam. When the substrate of the wafer is irradiated with 40 to 80 pulses of the pulsed laser beam for the purpose of forming the via hole reaching the bonding pad, the heat generated upon irradiation with the pulsed laser beam might be accumulated to reach the melting point of the bonding pad, resulting in that the bonding pad is melted and a hole is thereby formed in the bonding pad.

### SUMMARY OF THE INVENTION

Accordingly, it is an object of the present invention to provide a via hole machining method by which a substrate constituting a wafer can be provided with via holes reaching bonding pads, without melting the bonding pads.

In accordance with an aspect of the present invention, there is provided a via hole machining method for forming via holes in a wafer having a plurality of devices formed on a face side of a substrate, the devices being provided with bonding pads, the method including the step of forming a via hole reaching the bonding pad by irradiation with a pulsed laser beam from a back side of the substrate, wherein the energy density per pulse of the pulsed laser beam is set at such a value that ablation of the substrate will occur but ablation of the bonding pad will not occur, and the time interval of pulses of the pulsed laser beam is set at a value of not less than 150 microseconds.

Preferably, the energy density per pulse of the pulsed laser beam is set in the range of 40 to 20 J/cm². In addition, the time interval of pulses of the pulsed laser beam is desirably set in the range of 150 to 300 microseconds (μs).

In the via hole machining method according to the present invention, the energy density per pulse of the pulsed laser beam is set at such a value that ablation of the substrate will occur but ablation of the bonding pad will not occur, and the time interval of the pulses of the pulsed laser beam is set at a value of not less than 150 microseconds. Therefore, the heat generated upon irradiation with one pulse is cooled down by the time of irradiation with the next pulse, so that the via hole reaching the bonding pad can be formed in the substrate, without melting the bonding pad.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a semiconductor wafer as a wafer to be processed by a via hole machining method according to the present invention;

FIG. 2 is a perspective view of an essential part of a laser beam machining system for carrying out the via hole machining method according to the present invention;

FIG. 3 is a block diagram of laser beam irradiation means with which the laser beam machining system shown in FIG. 2 is equipped;

FIG. 4 is an illustration of a via hole forming step in the via hole machining method according to the present invention;

FIG. 5 is a partial enlarged sectional view of a semiconductor wafer in which via holes are formed by carrying out the via hole forming step in the via hole machining method according to the present invention; and

FIG. 6 is a block diagram of another embodiment of the laser beam irradiation means with which the laser beam machining system shown in FIG. 2 is equipped.

### DETAILED DESCRIPTION OF THE PREFERRED EMBODIMENTS

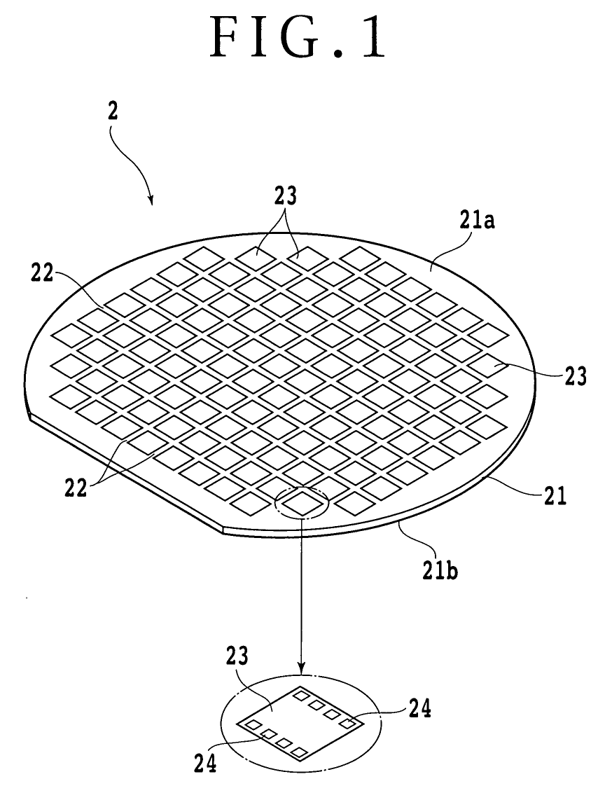

Now, the via hole machining method according to the present invention will be described in detail below, referring to the attached drawings. FIG. 1 shows a perspective view of a semiconductor wafer 2 as a wafer to be processed by the via hole machining method according to the present invention. The semiconductor wafer 2 shown in FIG. 1 has a plurality of regions demarcated by a plurality of streets 22 arranged in a lattice form on the face side 21a of a substrate 21 formed of silicon and having a thickness of, for example, 100 μm, and devices 23 such as ICs and LSIs are formed respectively in the demarcated regions. All the devices 23 have the same configuration. Each of the devices 23 is provided on its surface with a plurality of bonding pads 24. The bonding pads 24 are formed of a metallic material such as aluminum, copper, gold, platinum, nickel in a thickness of 1 to 5 μm.

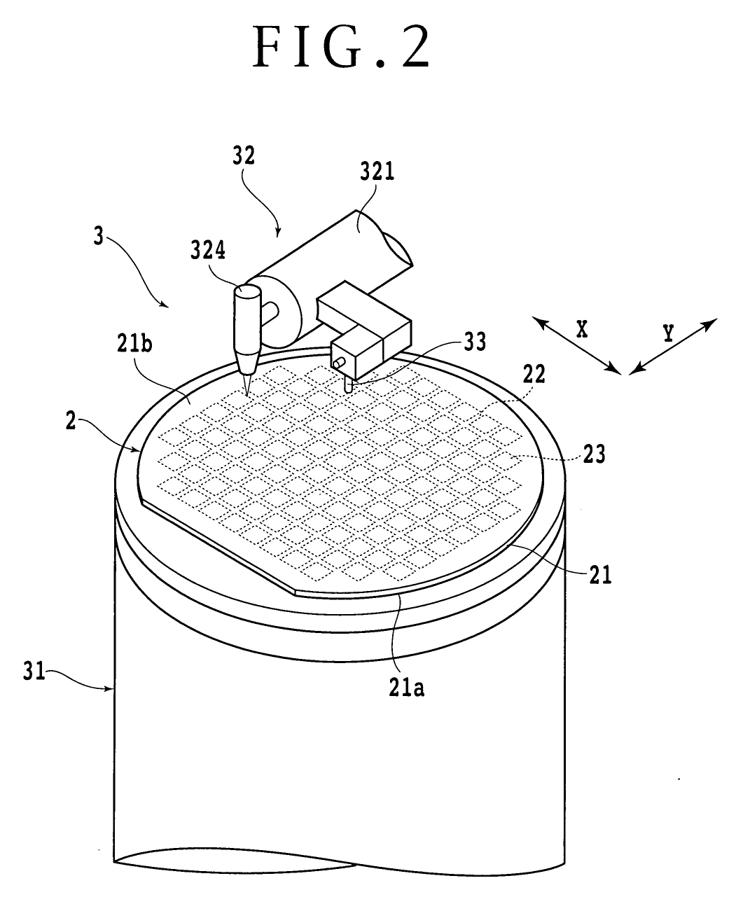

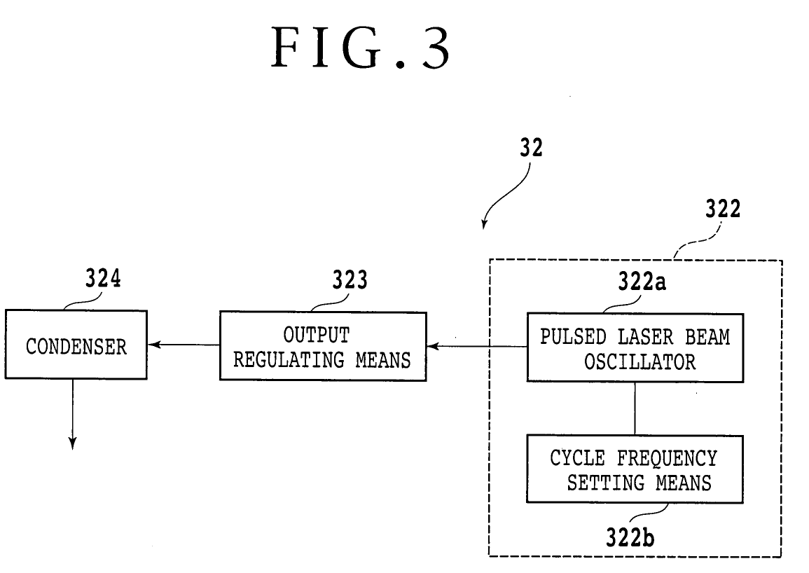

The semiconductor wafer 2 is irradiated with a pulsed laser beam from the side of the back side 21b of the substrate 21, whereby via holes reaching the bonding pads 24 are bored. Boring of the via holes in the substrate 21 of the semiconductor laser 2 is carried out by use of a laser beam machining system 3 shown in FIGS. 2 and 3. The laser beam machining system 3 shown in FIGS. 2 and 3 includes a chuck table 31 for holding the work, and laser beam irradiation means 32 for irradiating the work held on the chuck table 31 with a laser beam. The chuck table 31 is so configured as to hold the work by suction, to be moved in a machining feed direction indicated by arrow X in FIG. 2 by a machining feeding mechanism (not shown), and to be moved in an index feed direction indicated by arrow Y by an index feeding mechanism (not shown).

The laser beam irradiation means 32 includes a hollow cylindrical casing 321 disposed to be substantially horizontal. As shown in FIG. 3, pulsed laser beam oscillating means 322 and output regulating means 323 are disposed in the casing 321. The pulsed laser beam oscillating means 322 includes a pulsed laser beam oscillator 322a composed by use of a YAG laser oscillator or a YVO4 laser oscillator, and cycle frequency setting means 322b annexed thereto. The output regulating means 323 regulates the output of a pulsed laser beam oscillated from the pulsed laser beam oscillating means 322 to a desired output. The pulsed laser beam oscillating means 322 and the output regulating means 323 are controlled by control means (not shown). A condenser 324 incorporating a condenser lens (not shown) composed of a set of lenses with a form which itself may be a known one is mounted to a tip portion of the casing 321. The condenser 324 condenses the pulsed laser beam oscillated from the pulsed laser beam oscillating means 322 to a predetermined condensed spot diameter, for irradiating the work held on the chuck table 31 with the condensed laser beam.

The laser beam machining system 3 shown includes image pickup means 33 mounted to a tip portion of the casing 321 constituting the laser beam irradiation means 32. The image pickup means 33 includes not only a normal image pickup device (CCD) for imaging by use of visible rays but also infrared (IR) illumination means for irradiating the work with IR rays, optical system for capturing IR rays radiated by the IR illumination means, image pickup device (IR CCD) for outputting an electrical signal corresponding to the IR rays captured by the optical system and a signal of the image picked up is sent by the image pickup means 33 to the control means (not shown).

Now, description will be made of the via hole machining method in which via holes reaching the bonding pads 24 are formed in the substrate 21 of the semiconductor wafer 2 shown in FIG. 1 by use of the laser beam machining system 3 shown in FIGS. 2 and 3. First, as shown in FIG. 2, the face side 2a of the semiconductor wafer 2 is mounted on the chuck table 31 of the laser beam machining system 3, and the semiconductor wafer 2 is held on the chuck table 31 by suction. Therefore, the semiconductor wafer 2 is held, with its back side 21b up.

The chuck table 31 with the semiconductor wafer 2 held thereon by suction as above-mentioned is positioned to a position directly under the image pickup means 33 by the machining feeding mechanism (not shown). When the chuck table 31 is thus positioned to the position directly under the image pickup means 33, the semiconductor wafer 2 on the chuck table 31 is positioned into a predetermined position in a coordinate system. In this condition, an alignment operation is carried out to check whether or not the streets 22 formed in a lattice pattern in the semiconductor wafer 2 held on the chuck table 31 are set in parallel to the X direction and the Y direction. More specifically, the semiconductor wafer 2 held on the chuck table 31 is imaged by the image pickup means 33, and an image machining such as pattern matching is conducted to thereby perform the alignment operation. In this instance, the face side 21a of the substrate 21 provided with the streets 22 of the semiconductor wafer 2 is located on the lower side. However, since the image pickup means 33 includes image pickup means composed of the IR illumination means, the optical system for capturing IR rays, the image pickup device (IR CCD) for outputting an electrical signal corresponding to the IR rays, etc. as above-mentioned, the streets 22 can be imaged in a see-through manner from the side of the back side 21b of the substrate 21.

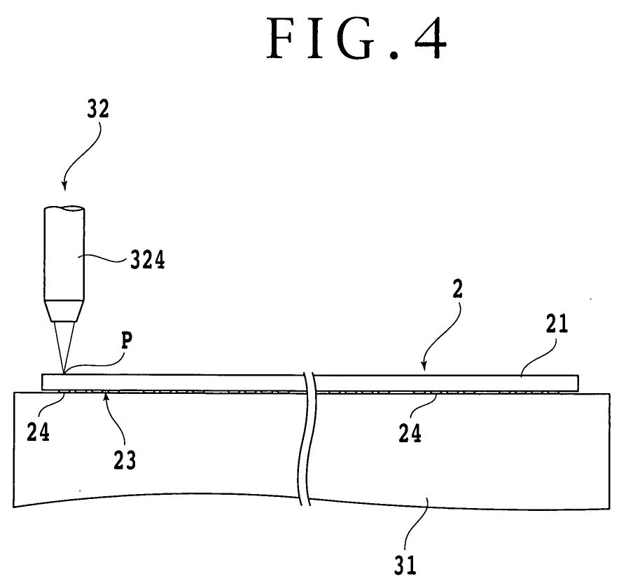

With the above-mentioned alignment operation carried out, the semiconductor wafer 2 held on the chuck table 31 is positioned to a predetermined position in the coordinate system. Incidentally, the design-basis positions in the coordinate system of the plurality of bonding pads 24 formed on the devices 23 formed on the face side 21a of the substrate 21 of the semiconductor wafer 2 are preliminarily stored in the control means (not shown) of the laser beam machining system 3. When the above-mentioned alignment operation is finished, the chuck table 31 is moved as shown in FIG. 4 so that the device 23, at the leftmost end in FIG. 4, of the plurality of devices 23 formed in a predetermined direction on the substrate 21 of the semiconductor wafer 2 is positioned to a position directly under the condenser 324. Then, the bonding pad 24, at the leftmost end, of the plurality of bonding pads 24 formed on the device 23 located at the leftmost end in FIG. 4 is positioned to the position directly under the condenser 324.

Next, the via hole forming step is carried out in which the laser beam irradiation means 32 is operated to radiate a pulsed laser beam from the condenser 324 to the work from the side of the back side 21b of the substrate 21, whereby a via hole extending from the back side 21b to reach the bonding pad 24 is formed in the substrate 21. In this case, the condensed spot P of the pulsed laser beam is adjusted to the vicinity of the back side 21b (upper surface) of the substrate 21. Incidentally, as the laser beam with which the work is irradiated, a pulsed laser beam with such a wavelength as to be absorbed by the substrate 21 formed of silicon (for example, 355 nm) is used, and the energy density per pulse of the pulsed laser beam is desirably set to a value at which ablation of the substrate 21 formed of silicon will occur but ablation of the bonding pad 24 formed of a metal will not occur, i.e., a value in the range of 40 to 20 J/cm².

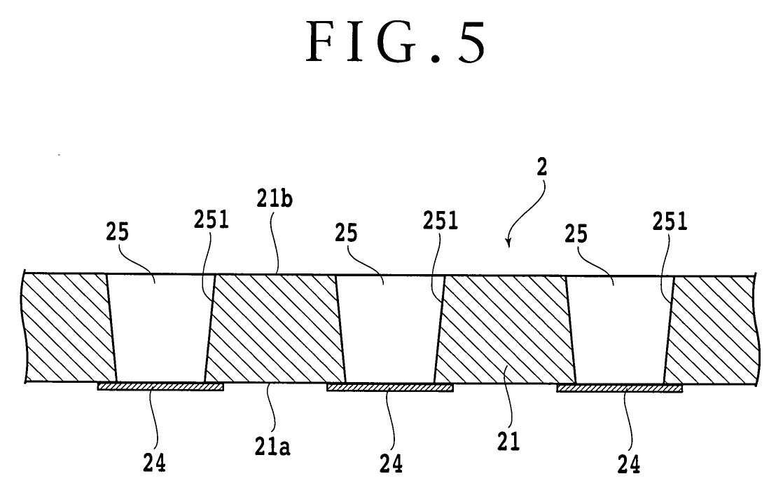

When the substrate 21 formed of silicon is irradiated with the pulsed laser beam having an energy density per pulse of 40 J/cm² from the side of the back side 21b, a hole with a depth of 2.5 μm can be formed in the substrate 21 by one pulse of the pulsed laser beam. Therefore, in the case where the substrate 21 has a thickness of 100 μm, it is possible by irradiation with 40 pulses of the pulsed laser beam to provide the substrate 21 with a via hole 25 extending from the back side 21b to reach the face side 21a, i.e., to reach the bonding pad 24, as shown in FIG. 5. Incidentally, in the case where a pulsed laser beam having an energy density per pulse of 20 J/cm² is used, it is possible by irradiating the substrate 21 with 80 pulses of the pulsed laser beam to provide the substrate 21 with a via hole 25 extending from the back side 21b to reach the face side 21a, i.e., to reach the bonding pad 24, as shown in FIG. 5.

Meanwhile, it has been found that even where the energy density per pulse of the pulsed laser beam is set to such a value that ablation of the substrate 21 formed of silicon will occur but ablation of the bonding pad 24 formed of a metal will not occur, i.e., a value in the range of 40 to 20 J/cm², the bonding pad 24 is melted and a hole is thereby formed if the time interval of the pulses of the pulsed laser beam used for irradiation therewith is short. More specifically, if the time interval of the pulses of the pulsed laser beam for irradiation is short, the work portion heated by irradiation with one pulse is not cooled before being irradiated with the next pulse, so that heat is accumulated to reach the melting point of the bonding pad 24, thereby causing fusion of the bonding pad 24.

Taking this into consideration, in order to examine the relationship between the time interval of the pulses of the pulsed laser beam and the melting of the bonding pad 24, the present inventors made the following experiment. A wafer in which an aluminum-made bonding pad with a thickness of 1 μm was formed on the face side of a silicon substrate having a thickness of 100 μm was prepared. The wafer was irradiated from the back side thereof with 40 pulses of a pulsed laser beam having an energy density per pulse of 40 J/cm², while varying the cycle frequency, to provide the silicon substrate with a via hole reaching the bonding pad. In this instance, the condensed spot diameter of the pulsed laser beam for irradiation was set to 70 μm. The experiment was conducted under the above-mentioned conditions while varying the cycle frequency of the pulsed laser beam from 1 kHz to 8 kHz. The results were as follows.

When the cycle frequency of the pulsed laser beam was in the range of 1 to 6 kHz, the bonding pad was not melted; however, when the cycle frequency of the pulsed laser beam was 7 kHz and when it was 8 kHz, the bonding pad was melted. Thus, it was found that the threshold cycle frequency of the pulsed laser beam in regard of melting of the bonding pad is present between 6 kHz and 7 kHz. In view of this, the experiment was further made while varying the cycle frequency of the pulsed laser beam in the range of 6 to 7 kHz, and, as a result, it was found that the bonding pad is melted at a cycle frequency of 6.7 kHz or above.

Where the cycle frequency of the pulsed laser beam is 6.7 kHz, the time interval of the pulses of the pulsed laser beam is 1/6700 seconds=0.00015 seconds=150 microseconds (μs). Therefore, when the time interval of the pulses of the pulsed laser beam is set to be not less than 150 microseconds (μs), the heat generated upon irradiation with one pulse is cooled down by the time of irradiation with the next pulse, so that a via hole reaching the bonding pad can be formed in the silicon substrate, without bringing about melting of the bonding pad. Thus, the via hole reaching the bonding pad can be formed without melting the bonding pad, by setting the time interval of the pulses of the pulsed laser beam at a value of not less than 150 microseconds (μs). Taking productivity into account, however, the time interval of the pulses of the pulsed laser beam is desirably set in the range of 150 to 300 microseconds (μs).

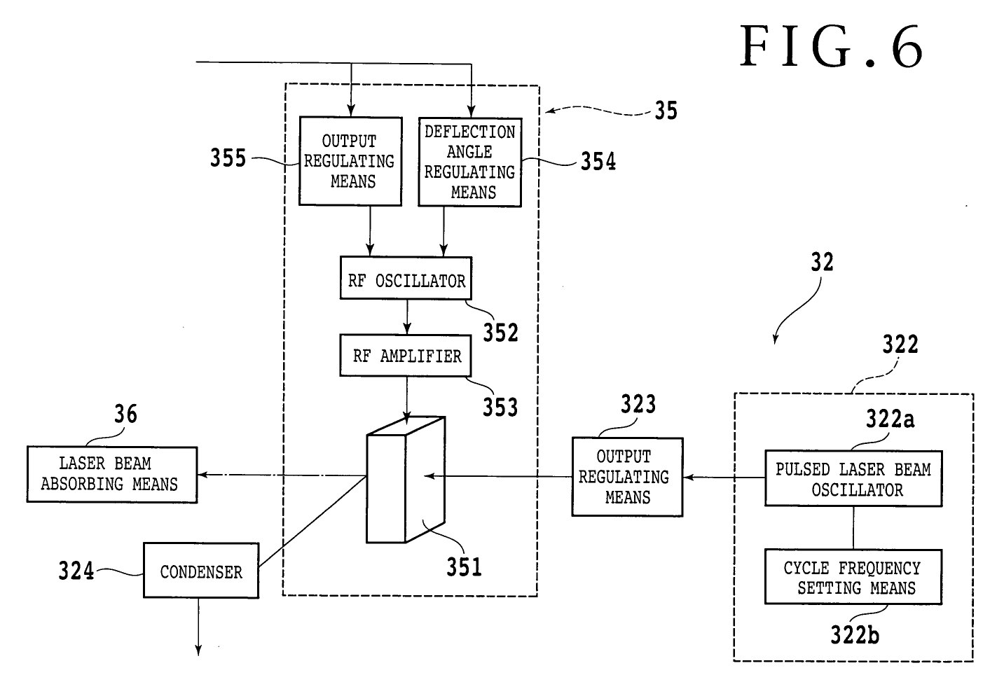

Incidentally, the time interval of the pulses of the pulsed laser beam can be set to a value of not less than 150 microseconds (μs), by setting the cycle frequency of the pulsed laser beam to a value of not more than 6.7 kHz. However, even where a pulsed laser beam with a cycle frequency of more than 6.7 kHz is used, the time interval of the pulses of the pulsed laser beam can be set to a value of not less than 150 microseconds (μs) by, for example, arranging acousto-optical deflection means between the output regulating means 323 and the condenser 324 in the laser beam irradiation means 32 of the laser beam machining system 3. Laser beam irradiation means equipped with the acousto-optical deflection means will be described below, referring to FIG. 6.

The laser beam irradiation means 32 shown in FIG. 6 includes acousto-optical deflection means 35 which is disposed between the output regulating means 323 and the condenser 324 and by which a laser beam oscillated from pulsed laser beam oscillating means 322 is deflected, for example, into the machining feed direction. The acousto-optical deflection means 35 includes: an acousto-optical device 351 by which the laser beam oscillated by the laser beam oscillating means 322 is deflected, for example, into the machining feed direction; an RF oscillator 352 for producing an RF (radio frequency) to be impressed on the acousto-optical device 351; an RF amplifier 353 for amplifying the power of the RF produced by the RF oscillator 352 and impressing the amplified RF power to the acousto-optical device 351; deflection angle regulating means 354 for regulating the frequency of the RF produced by the RF oscillator 352; and output regulating means 355 for regulating the amplitude of the RF produced by the RF oscillator 352. The acousto-optical device 351 can regulate the angle of deflection of the laser beam in correspondence with the frequency of the RF impressed, and can regulate the output of the laser beam in correspondence with the amplitude of the RF impressed. Incidentally, the deflection angle regulating means 354 and the output regulating means 355 are controlled by control means (not shown).

The acousto-optical deflection means 35 in the embodiment shown is configured as above-mentioned, and, where an RF is not impressed on the acousto-optical device 351, the pulsed laser beam oscillated from the pulsed laser beam oscillating means 322 is led through the output regulating means 323 and the acousto-optical device 351 to laser beam absorbing means 36, as indicated by the dot-dash line in FIG. 6. On the other hand, when an RF with a frequency of 10 kHz, for example, is impressed on the acousto-optical device 351, the pulsed laser beam oscillated from the pulsed laser beam oscillating means 322 is deflected as indicated by the solid line in FIG. 6, to be led to the condenser 324. Therefore, when the condition where the RF with a frequency of 10 kHz, for example, is impressed on the acousto-optical device 351 and the condition where no RF is impressed on the acousto-optical device 351 are alternately generated, the work is irradiated through the condenser 324 with the pulses, corresponding to one half the cycle frequency, of the pulsed laser beam oscillated from the pulsed laser beam oscillating means 322.

Therefore, the time interval of the pulses of the pulsed laser beam with which the work is irradiated is two times the (original) time interval of the pulses of the pulsed laser beam oscillated from the pulsed laser beam oscillating means 322. Accordingly, in the case where the cycle frequency of the pulsed laser beam oscillated from the pulsed laser beam oscillating means 322 is 10 kHz, operating the acousto-optical deflection means 35 in the above-mentioned manner results in that the time interval of the pulses of the pulsed laser beam with which the work is irradiated is ( 1/10000 seconds)×2=0.0002 seconds=200 microseconds (μs). Thus, the use of the acousto-optical deflection means 35 ensures that the time interval of the pulses of the pulsed laser beam with which the work is irradiated can be set to a value of not less than 150 microseconds (μs) even when a pulsed laser beam with a cycle frequency of higher than 6.7 kHz is used.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A via hole machining method for forming via holes in a wafer having a plurality of devices formed on a face side of a substrate, said devices being provided with bonding pads, said method comprising the step of:
forming a via hole reaching said bonding pad by irradiation with a pulsed laser beam from a back side of said substrate,
wherein the energy density per pulse of said pulsed laser beam is set at such a value that ablation of said substrate will occur but ablation of said bonding pad will not occur, and the time interval of pulses of said pulsed laser beam is set at a value of not less than 150 microseconds.

2. The via hole machining method as set forth in claim 1, wherein the energy density per pulse of said pulsed laser beam is set in the range of 40 to 20 J/cm².

3. The via hole machining method as set forth in claim 1, wherein the time interval of pulses of said pulsed laser beam is set in the range of 150 to 300 microseconds (μs).
